(19) United States
(12) Patent Application Publication
(10) Pub. No.: US 2025/0045264 A1
(43) Pub. Date: Feb. 6, 2025

(54) SYSTEMS AND METHODS FOR FILTERING HIGH VOLUME DATA

(71) Applicant: Cogility Software Corporation, Irvine, CA (US)

(72) Inventor: Michael Allen Latta, Greeley, CO (US)

(21) Appl. No.: 18/781,708

(22) Filed: Jul. 23, 2024

Related U.S. Application Data
(60) Provisional application No. 63/516,779, filed on Jul. 31, 2023.

(51) Int. Cl. G06F 16/22

(52) U.S. Cl. CPC G06F 16/2246

(57) ABSTRACT

Methods and systems for filtering high volume data are disclosed. The method includes obtaining reference data. The method further includes creating an index of reference data based on the obtained reference data. For each input record from a plurality of input records, the method further includes looking up the input record against the index of reference data to locate a match or a possible match, producing augmented data based on the input record and the located match or possible match, and publishing or storing the augmented data.

### CROSS REFERENCE TO RELATED APPLICATION

This application claims the benefit of U.S. Provisional Application No. 63/516,779 filed on Jul. 31, 2023, the disclosure of which is incorporated herein by reference in its entirety.

### FIELD OF THE INVENTION

Embodiments of the present disclosure relate generally to high volume data processing. More particularly, embodiments of the disclosure relate to systems and methods for filtering high volume data.

### BACKGROUND

Data analytics, which include analyzing of cyber data, trading data, advertisement data, etc., have been increasingly important to governments, businesses, organizations, and individuals as they can help understand patterns and trends. In several fields of data analytics, data generally arrives in high volume and needs to be filtered to a usable data rate for a limited number of target entities.

For example, in stock trading, a data analytics system may need to accept high volume trading data and attach enrichments from reference sources to make an automated trading decision. In advertisement (or ad) networks requests are received for ad data that must be responded with very low latency when matching to a large number of potential ad placements. In cyber security, it is important to match network traffic logs to Internet Protocol (IP) addresses or ranges of IP addresses to attribute activities to target entities.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a system architecture for a data analytics system according to an embodiment.

FIG. 2 is a block diagram illustrating a data analytics system according to an embodiment.

FIG. 3 is a flow diagram illustrating a process of filtering high volume data according to an embodiment.

FIG. 4 is a flow diagram illustrating a process of building or creating an index of reference data according to another embodiment.

FIG. 5 is a flow diagram illustrating a process of input record lookup according to an embodiment.

FIG. 6 is a flow diagram illustrating a process of data augmentation according to an embodiment.

FIG. 7 is an embodiment of a computer system that may be used to support the systems and operations discussed herein.

### DETAILED DESCRIPTION

Various embodiments and aspects of the disclosure will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present disclosure. However, in certain instances, well-known or conventional details are not described in order to provide a concise discussion of embodiments of the present disclosure.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to some embodiments, unique systems and methods provided herein address data analytic use cases (e.g., stock trading, ad networks, cyber security, etc.) to simultaneously attach enrichment data and limit output data rate to matching entries.

According to one aspect, a method of filtering high volume data is provided. The method may include obtaining reference data; creating an index of reference data based on the obtained reference data; and for each input record from a plurality of input records, looking up the input record against the index of reference data to locate a match or a possible match, producing augmented data based on the input record and the located match or possible match, and publishing or storing the augmented data.

According to another aspect, a system for filtering high volume data is provided. The system may include one or more processors, and a memory coupled to the processor(s) to store instructions, which when executed by the processor(s), cause the processor(s) to perform operations. The operations can comprise: obtaining reference data; creating an index of reference data based on the obtained reference data; and for each input record from a plurality of input records, looking up the input record against the index of reference data to locate a match or a possible match, producing augmented data based on the input record and the located match or possible match, and publishing or storing the augmented data.

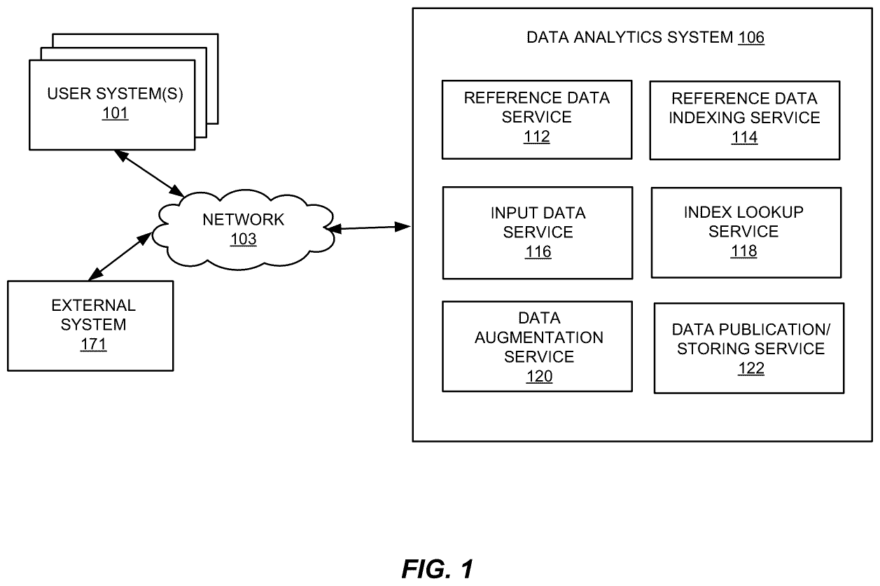

FIG. 1 is a block diagram illustrating a system architecture for a data analytics system according to an embodiment. Referring to FIG. 1, system 100 includes, but is not limited to, one or more user systems 101, a network 103, a data analytics system 106, and an external system 171. User system(s) 101 may be communicatively coupled (or synchronously connected or asynchronously connected) to data analytics system 106 over network 103. User system(s) 101 may be any type of devices such as a host or server, a personal computer (e.g., desktops, laptops, and tablets), a “thin” client, a personal digital assistant (PDA), a Web enabled appliance, a mobile phone (e.g., Smartphone), a wearable device (e.g., Smartwatch), Internet of Things (IoT) device, etc. In some embodiments, user system(s) 101 may be in control of a user (e.g., employee, staff, member, contractor, etc.) and may be used to perform enterprise functions that require access to organization/company systems.

With continued reference to FIG. 1, network 103 may be any type of networks such as a local area network (LAN), a wide area network (WAN) such as the Internet, a fiber network, a storage network, or a combination thereof, wired or wireless. Data analytics system 106 is communicatively coupled or connected to external system 171, which may be over a network similar to network 103. Data analytics system 106 may include or represent any kind of server or a cluster of servers, such as Web or cloud servers, application servers, backend servers, or a combination thereof.

External system 171 can be any computer system with computational and network-connectivity capabilities to interface with data analytics system 106. In an embodiment, external system 171 may include multiple computer systems. That is, external system 171 may be a cluster of machines sharing the computation and source data storage workload. External system 171 may be part of a government, business, or organization performing government functions, business functions, or organizational functions, respectively.

As shown, data analytics system 106 may include, but not limited to, reference data service 112, reference data indexing service 114, input data service 116, index lookup service 118, data augmentation service 120 and data publication or storing service 122.

In an embodiment, reference data service 112 may load and cache reference data for fast access, for example into a data store (e.g., database), where the reference data is to be used for filtering and enrichment. Reference data indexing service 114 may create or build an index of the reference data loaded and cached by reference data service 112. When building the index of the reference data, reference data indexing service 114 may select a method that is most applicable to the domain in question, as described in more detail herein below. Input data service 116 may read input data or records of a specific format. When reading the input records, service 116 can be adapted to the format of the incoming data to allow the data to be used in many related use cases and also allow for operational reality of schema changes over time. Thus, this relies on configurable input data or records for all inputs and the ability to define outside of the code the set of fields to match against and the type of match required.

In an embodiment, index lookup service 118 may perform a data or record lookup against an index to locate the highest quality matches. Data augmentation service 120 may serve to augment the data or record for output. For example, service 120 can be configured to be a value copying service from the highest quality match or from all matches, and may include the ability to specify computations to be performed (e.g., summations, counts, averages, or other functions) on the input, the highest quality match and/or all matches. This flexibility and ability to specify the computations outside of the operational code can allow system 106 to be deployed to solve many related problems. In an embodiment, data publication/storing service 122 may publish the final data or records by producing the final data or records to a streaming system (e.g., Kafka, Polaris, Kinesis, etc.). In another embodiment, service 122 may store the final data or records by writing the data or records to a data store or database (e.g., Elastic Search, PostgreSQL, etc.).

Some or all of services 112-122 may be implemented in software, hardware, or a combination thereof. For example, these services may be installed on persistent storage device, loaded into a memory, and executed by one or more processors of one or more servers. Note that some or all of these services may be communicatively coupled to or integrated with some or all services/processes of the server(s). Some of services 112-122 may be integrated together as an integrated process/service.

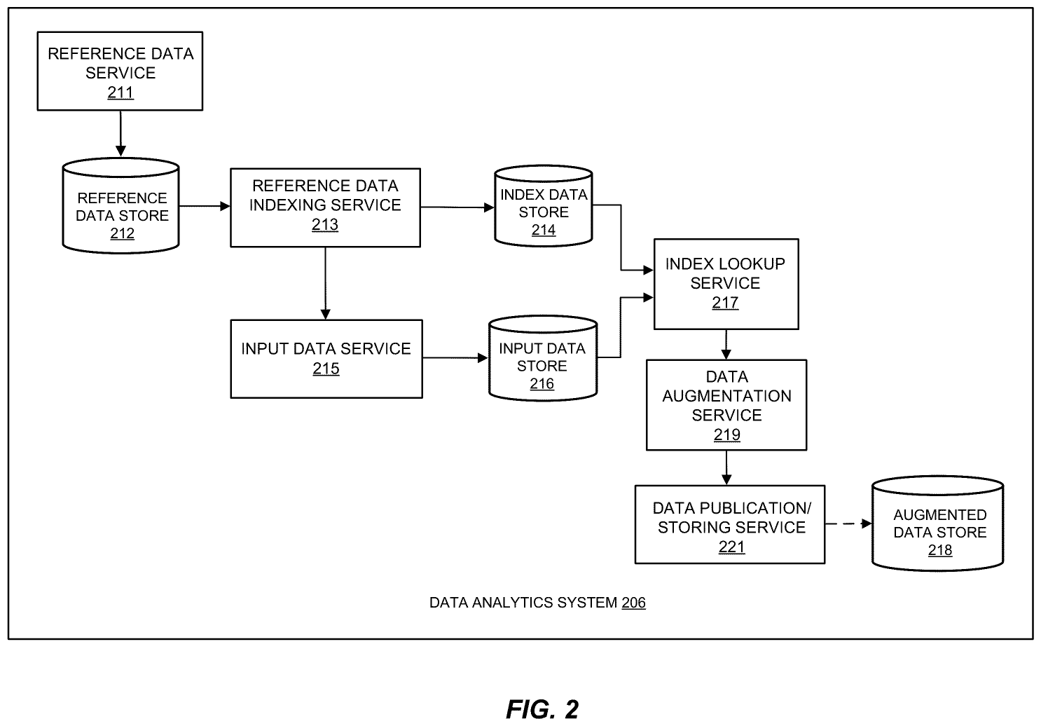

FIG. 2 is a block diagram illustrating a data analytics system according to an embodiment. Referring to FIG. 2, data analytics system 206 may include, but not limited to, reference data service 211, reference data indexing service 213, input data service 215, index lookup service 217, data augmentation service 219, and data publication/storing service 221.

In an embodiment, reference data service 211 may load and cache reference data to reference data store 212 (for fast access) to be used for filtering and enrichment. Reference data store 212 may be a database or other storage of the data analytics system 206 that stores reference data. This reference data may accept streaming updates from a data stream at lower volume in cases where such updates are not applied to historical data received prior to the updates. In an embodiment, reference data service 211 may read or obtain the reference data by polling a streaming data source, receive the reference data from the streaming data source that pushes the reference data to service 112, and/or periodically read the reference data from a data store or database (e.g., Elastic Search, PostgreSQL, AWS Aurora PostgreSQL, MongoDB, etc.) or another passive data source on a periodic or continuous basis, then cache the obtained reference data into reference data store 212. The reference data can be represented in different formats (e.g., CSV, JSON, XML, RDF, etc.), and may represent a set of fields relating to an entity. For example, with respect to cyber security, an entity can be an IP address, a domain, a range of IP addresses, or a corporation that may be an aggregate of any or all of these.

Reference data indexing service 213 may query the cache of reference data from reference data store 212, and create an index of reference data for a matching process tuned to the type of matching required. For example, when building or creating the index of reference data, reference data indexing service 213 may employ or select a process that is most application to a domain in question. As an example, with respect to cyber security IP addresses and ranges (entity), a trie data structure (e.g., trie-tree) may be used. In this indexing process, bit positions of an IP address or range may be treated separately when building a trie data structure. For example, at each node of the trie data structure, the branches for values of 0 or 1 in that bit position and a third position may reference what entity is represented by a range containing ancestor bits. This process produces linear processing time for any number of entity addresses being indexed and linear look up time. In other examples, such as domain names and other full string fields, a hash map can be utilized. For fields that may require more flexible matching, many processes can be used to perform similarity indexing or partial string matching, including using explicit value mapping from input values to reference values in a hash map for that purpose. Once the index is created or built for the cached reference data, reference data indexing service 213 may store the index in index data store 214, and input data service 215 may begin reading raw input data or sources. Index data store 214 may be a database or other storage of the data analytics system 206 that stores an index of reference data.

In an embodiment, when reading input data or records, input data service 215 may adapt to a format of the incoming data, to allow the same system to be used in many related use cases and to also allow for operational reality of schema changes over time. This relies on configurable input data or records for all inputs and the ability to define outside the code the set of fields to match against and the type of match required. Once the input records are read, input data service 215 may store the input records in input data store 216. Input data store 216 may be a database or other storage of the data analytics system 206 that stores input data.

Index lookup service 217 may query the index data store 214 and input data store 216 to respectively obtain an index of reference data and input records. For each input record, index lookup service 217 may compare the input record to the index to determine whether it is applicable to a set of target entities. In some embodiments, a set of target entities is referred to as a subset of all possible entities in the incoming data. In some cases, the approach may be applicable for a full set of incoming data, in which case, the target entities can be all entities. In the case of cyber security, for example, the target entities may be a company and its suppliers, or suppliers to a single project/program, etc.

In an embodiment, when performing an input record lookup against the index, index lookup service 217 may locate the highest quality matches. With respect to IP addresses, for example, the highest quality match may be the smallest IP address range applicable to the input record. When using a trie data structure (e.g., trie-tree), or any suitable data structure, for this purpose, in an embodiment, index lookup service 217 may proceed through the bits of the input IP address or IP address range looking for ranges or exact matches. When a matching entry in the trie data structure is found, index lookup service 217 may push the matching entry onto a stack. When the traversal of the trie data structure reaches the bottom of the data structure or has no further entry that matches the input record, the top entry in the stack may be determined to be the highest quality match. In another embodiment, more than the top match can be used in augmentation. For example, if the highest quality match is a small IP address range owned by company A, but a larger IP address range overlaps this (e.g., an IP range belonging to a hosting provider like AWS® (Amazon Web Services)), the larger IP address range can be encoded in the output to indicate that the highest quality match is cloud server hosted rather than self-hosted. This can greatly impact the quality of the analysis and the assessment of the cyber vulnerability of the target IP address.

If a matching entry is found, data augmentation service 219 may augment the entry for output by generating a configured set of additional data from the combination of the reference data and the input record. For example, data augmentation service 219 may perform value copying from the highest quality match or from all matches. Data augmentation service 219 may also include the ability to specify computations to be performed (e.g., sums, counts, averages, or other functions) on the input record, the highest quality match, and/or all matches. This flexibility and ability to specify the computations outside the operational code allows the same system to be deployed to solve many related problems. In cyber security, for example, this can include filtering NetFlow data, filtering vulnerability scan data, filtering audit logs, etc. Specification of the computations in simple cases can be through environment variables, configuration settings, or in configuration files, and in more elaborate use cases involve a graphical user interface (GUI) tool to specify the computations to be performed graphically, using other UI methods, or a file containing instructions in a structured format (e.g., JSON, XML, DSL).

In an embodiment, data publication/storing service 221 may publish or store the resulting augmented data or entry for subsequent usage. For example, data publication/storing service 221 may produce a final record (e.g., an augmented input record) to a streaming system (e.g., Kafka, Polaris, Kinesis, etc.), or store (e.g., write) the final record to augmented data store 218. The final record may include all fields and key data required by data publication/storing service 221. Augmented data store 218 may be a database (e.g., Elastic Search, PostgreSQL, etc.) or other storage of the data analytics system 206 that stores augmented data.

It is noted that while services 211-221 are presented as sequential, they can occur concurrently (e.g., services 211 and 213, and services 215-221). This concurrency can be either in one program with iterating sequential tasks, or concurrently running separate tasks or executed on separate computers communicating to achieve the resulting processing flows. In this way, embodiments of the disclosure reduce the computation and latency required in streaming systems in particular when attempting to correlate reference data with a large number of high rate inputs.

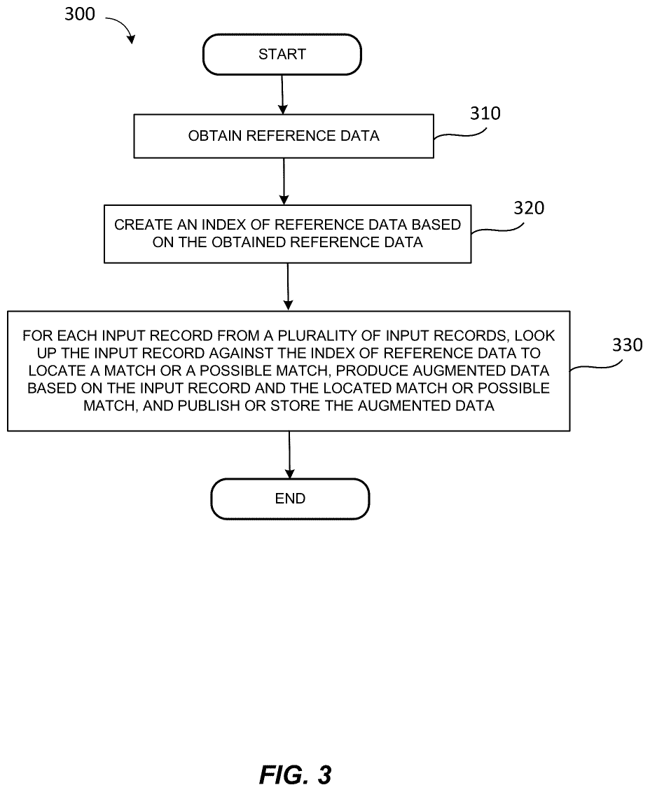

FIG. 3 is a flow diagram illustrating a process of filtering high volume data according to an embodiment. Process 300 may be performed by processing logic which may include software, hardware, or a combination thereof. For example, process 300 may be performed by one or more of services 211-221 of FIG. 2.

Referring to FIG. 3, at block 310, the processing logic may obtain reference data. At block 320, the processing logic may create an index of reference data based on the obtained reference data. At block 330, for each input record from a plurality of input records, the processing logic may look up the input record against the index of reference data to locate a match or a possible match, produce augmented data based on the input record and the located match or possible match, and publish or store the augmented data.

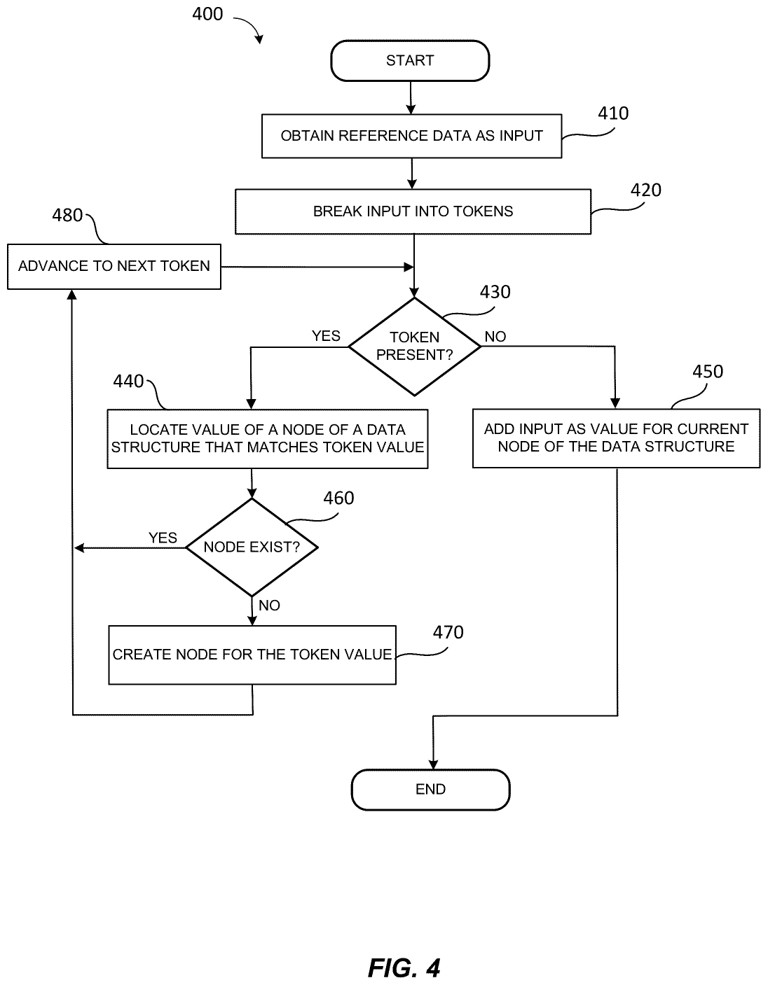

FIG. 4 is a flow diagram illustrating a process of building or creating an index of reference data according to another embodiment. Process 400 may be performed by processing logic which may include software, hardware, or a combination thereof. For example, process 400 may be performed by reference data indexing service 213 of FIG. 2.

Referring to FIG. 4, at block 410, the processing logic may obtain input data (e.g., reference data). For example, the processing logic may query the cache of reference data from reference data store 212 to obtain the reference data as one or more inputs. At block 420, for each input, the processing logic may break or split the input data into tokens (e.g., bits with respect to the cyber security example). The string of tokens may be used to iterate through nodes of the index to find the best match. For example, each field separated by a period in an IP address can be represented as a byte (8-bit binary value). Thus, an IP address of 1.2.3.4 can be represented as 00000001 00000010 00000011 00000100 bits. Starting with a top node (n) and a first token (t), the processing logic may iterate moving n to a next node with a matching value to t.

At block 430, the processing logic may determine whether a token is present. If so, the processing logic proceeds to block 440. At block 440, the processing logic may locate a node of a data structure (e.g., trie tree or any suitable data structure) having a value that matches a value of the token. At block 460, the processing logic may determine whether the node exists. If so, the processing logic proceeds to block 480. Otherwise, the processing logic proceeds to block 470. At block 480, the processing logic may advance to the next token, then return to block 430. At block 470, the processing logic may create a node for the value of the token, then proceed to block 480 to advance to the next token.

Returning to block 430, if it is determined that the token is not present, the processing logic proceeds to block 450, where the processing logic may add the input data as a value for the current node of the data structure.

If all tokens have been used, the value of the node n may be set to the entity being indexed. In the cyber security scenario, for example, each node may have three children (0,1,v), though it is not limited to this number. In this scenario, the value of the v child may represent the value for that node. In advanced cases, there may be multiple indices created for different reference data sets and applied to each input independently.

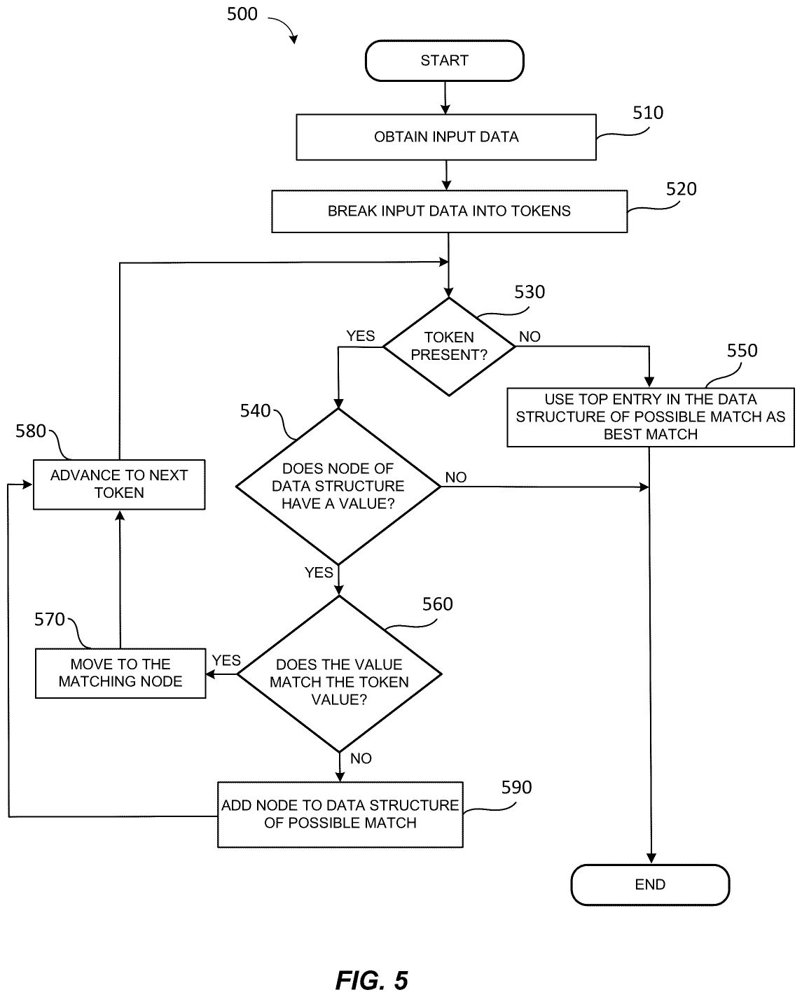

FIG. 5 is a flow diagram illustrating a process of input record lookup according to an embodiment. Process 500 may be performed by processing logic which may include software, hardware, or a combination thereof. For example, process 500 may be performed by index lookup service 217 of FIG. 2.

Referring to FIG. 5, at block 510, the processing logic may obtain input data or records. For example, the processing logic may query input data from input data store 216 to obtain the input data. At block 520, the processing logic may break or split the input data into tokens. For example, for each input data or record, the processing logic may break the input data into tokens (e.g., bits with respect to the cyber security example). For example, each field separated by a period in an IP address can be represented as a byte (8-bit binary value). However, not all token streams are full length, and an IP address range may have a subset of the possible token length. Thus, the goal is to locate the most narrow match so the index (e.g., trie data structure) may be traversed to look for the deepest match.

At block 530, the processing logic may determine whether a token is present. If a token is present, the processing logic proceeds to block 540, Otherwise, the processing logic proceeds to block 550.

At block 540, the processing logic may determine whether a node of a data structure has a value. The node, for example, may be the top or parent node of a trie data structure, or any suitable data structure, representing an index of reference data, as previously described. If the node has a value, the processing proceeds to block 560. Otherwise, if the node does not have a value, process 500 may end.

At block 560, the processing logic may determine whether the value of the node matches the value of the token. If the node value matches the token value, the processing logic proceeds to block 570. Otherwise, if the node value does not match the token value, the processing logic proceeds to block 590, where the node may be added as an entry to a data structure of possible match (e.g., a stack). That is, the node may be pushed onto the data structure as a possible matching node.

At block 570, the processing logic may move the pointer to the matching node (e.g., parent or child node), and in some embodiments, add the matching node as an entry to a data structure of matching reference data. For example, the processing logic may push the matching node onto a stack of matching reference data. The processing logic then proceeds to block 580, where the processing logic may advance to a next token and return to block 530.

Returning to block 550, if a token is not present, it may indicate that all tokens have been processed. In this scenario, the processing logic may use the top entry of the data structure of possible match (e.g., a stack) as the best match, and in some embodiments, add the top entry to the data structure of matching reference data.

It is noted that while an index of reference data is described herein, in advanced cases, there may be multiple indices resulting in multiple matching data structures (e.g., stacks).

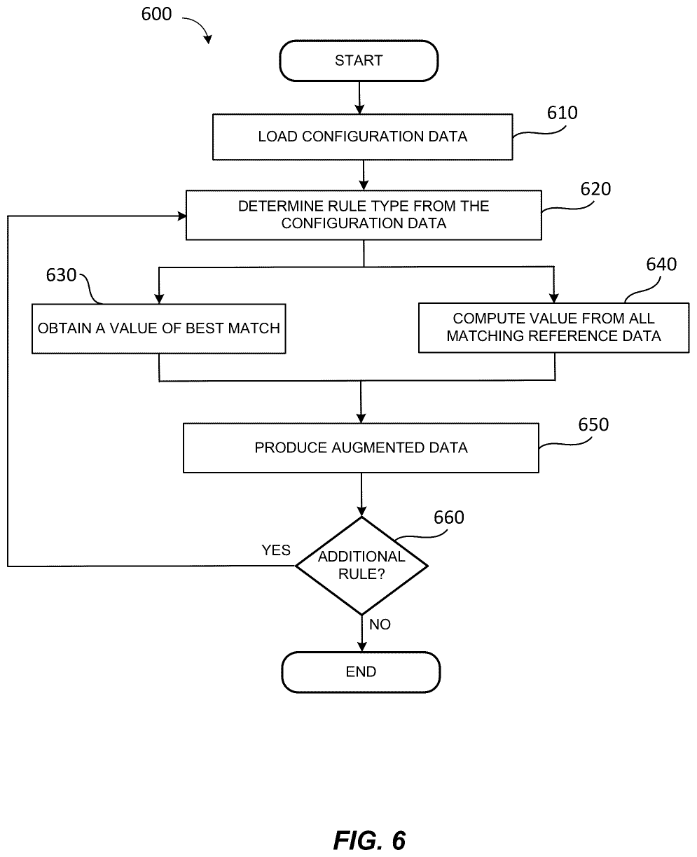

FIG. 6 is a flow diagram illustrating a process of data augmentation according to an embodiment. Process 600 may be performed by processing logic which may include software, hardware, or a combination thereof. For example, process 600 may be performed by data augmentation service 219 of FIG. 2.

Referring to FIG. 6, at block 610, the processing logic may load or read configuration data for augmentation, where the configuration data is to be used for an input type. At block 620, the processing logic may determine a rule type for augmentation based on the configuration data. For example, based on a rule type, which may be included in the configuration data, the processing logic may proceed to block 630 or block 640.

At block 630, the processing logic may obtain a value of best match. For example, in an embodiment, the processing logic may obtain the value of best match from a top entry of the data structure of possible match, as previously described. In another embodiment, a computation on best match (e.g., average, sum, median, minimum (min), maximum (max), values to an array, convert to string, convert to number, etc.) may be performed on the entries of the data structure of possible match to obtain the value depending on the rule type. At block 640, the processing logic may compute a value from each or all of the matching reference data or records. For example, the processing logic may traverse through all entries of the data structure of matching reference data to compute or obtain one or more values from all matching reference data. When computing the value(s) from the matching reference data or records, the rule type may define as to how the computation (e.g., average, sum, median, min, max, values to an array, convert to string, convert to number, etc.) is performed on the matching records.

At block 650, the processing logic may produce augmented data for output. For example, in the case of the value of best match obtained from block 630, the processing logic may attach or copy the value of best match to the input record used to locate the node with value, as previously described with respect to FIG. 5, to produce the augmented data (or augmented input record). In some embodiments, the processing logic may copy the value into a field of the augmented data, which may include the input record.

In the case of the value(s) computed or obtained from all matching reference data (block 640), the processing logic may attach or copy the value(s) to the input records used to locate the matching nodes having the values to produce the augmented data. In some embodiments, the processing logic may place the value(s) into different fields of the augmented data, which may include the input records. In other embodiments, depending on the rule type, the processing logic may replace the input records from the augmented data with the computed value(s) or the copied value of best match.

At block 660, the processing logic may determine whether there exists an additional rule from the configuration data. If so, the processing logic returns to block 620 to determine the rule type of the additional rule. Otherwise, process 600 may end.

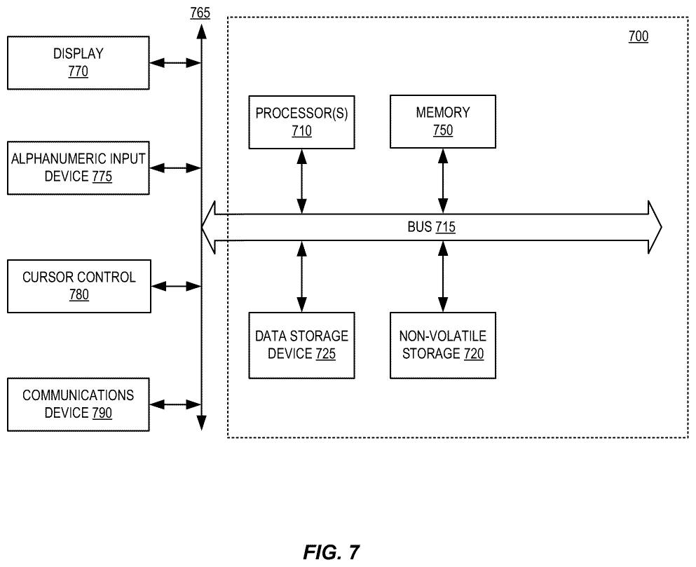

FIG. 7 is an embodiment of a computer system that may be used to support the systems and operations discussed herein. The data processing system illustrated in FIG. 7 includes a bus or other internal communication means 715 for communicating information, and one or more processors 710 coupled to the bus 715 for processing information. The system further comprises a random access memory (RAM) or other volatile storage device 750 (referred to as memory), coupled to bus 715 for storing information and instructions to be executed by processor(s) 710. Main memory 750 also may be used for storing temporary variables or other intermediate information during execution of instructions by processor(s) 710. The system also comprises a read only memory (ROM) and/or static storage device 720 coupled to bus 715 for storing static information and instructions for processor(s) 710, and a data storage device 725 such as a magnetic disk or optical disk and its corresponding disk drive. Data storage device 725 is coupled to bus 715 for storing information and instructions.

The system may further be coupled to a display device 770, such as a light emitting diode (LED) display or a liquid crystal display (LCD) coupled to bus 715 through bus 765 for displaying information to a computer user. An alphanumeric input device 775, including alphanumeric and other keys, may also be coupled to bus 715 through bus 765 for communicating information and command selections to processor(s) 710. An additional user input device is cursor control device 780, such as a touchpad, mouse, a trackball, stylus, or cursor direction keys coupled to bus 715 through bus 765 for communicating direction information and command selections to processor(s) 710, and for controlling cursor movement on display device 770.

Another device, which may optionally be coupled to computer system 700, is a communication device 790 for accessing other nodes of a distributed system via a network. The communication device 790 may include any of a number of commercially available networking peripheral devices such as those used for coupling to an Ethernet, token ring, Internet, or wide area network. The communication device 790 may further be a null-modem connection, or any other mechanism that provides connectivity between the computer system 700 and the outside world. Note that any or all of the components of this system illustrated in FIG. 7 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 750, mass storage device 725, or other storage medium locally or remotely accessible to processor 710.

It will be apparent to those of ordinary skill in the art that the system, method, and process described herein can be implemented as software stored in main memory 750 or read-only memory 720 and executed by processor(s) 710. This control logic or software may also be resident on an article of manufacture comprising a computer readable medium having computer readable program code embodied therein and being readable by the mass storage device 725 and for causing the processor(s) 710 to operate in accordance with the methods and teachings herein.

The embodiments discussed herein may also be embodied in a handheld or portable device containing a subset of the computer hardware components described above. For example, the handheld device may be configured to contain only the bus 715, the processor(s) 710, and memory 750 and/or 725. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include processor(s) 710, a data storage device 725, a bus 715, and memory 750, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A computer-implemented method of filtering high volume data, comprising:
obtaining reference data;
creating an index of reference data based on the obtained reference data; and
for each input record from a plurality of input records,
looking up the input record against the index of reference data to locate a match or a possible match,
producing augmented data based on the input record and the located match or possible match, and
publishing or storing the augmented data.

2. The method of claim 1, wherein creating the index of reference data comprises:
splitting the reference data into a plurality of tokens;
locating a node of a data structure having a value that matches a value of a token among the plurality of tokens;
determining whether the node of the data structure exists;
in response to determining that the node exists, advancing to a next token among the plurality of tokens; and
in response to determining that the node does not exist, creating the node for the value of the token.

3. The method of claim 2, wherein creating the index of reference data further comprises:
adding the reference data as a value of a current node of the data structure.

4. The method of claim 3, wherein the data structure is a trie data structure.

5. The method of claim 1, wherein looking up the input record against the index of reference data to locate the match or possible match comprises:
splitting the input record into a plurality of tokens;
determining whether a node of a data structure has a value, wherein the data structure represents the index of reference data;
in response to determining that the node of the data structure has a value, determining whether the value matches a value of a token among the plurality of tokens;
in response to determining that the value matches the value of the token, moving to the node, and advancing to a next token among the plurality of tokens; and
in response to determining that the value does not match the value of the token, adding the node to a data structure of possible match.

6. The method of claim 5, wherein looking up the input record against the index of reference data to locate the match or possible match further comprises:
using a top entry in the data structure of possible match as a best match.

7. The method of claim 1, wherein producing the augmented data comprises:
loading configuration data;
determining a rule type from the configuration data;
in response to the rule type, obtaining or computing a value of best match from a data structure of possible match, or computing a value from one or more matching reference data entries of a data structure of matching reference data; and
attaching the obtained or computed value of best match, or the computed value from the one or more matching reference data entries to the input record to produce the augmented data.

8. The method of claim 7, wherein the data structure of possible match and the data structure of matching reference data are a stack data structure.

9. The method of claim 1, wherein publishing or storing the augmented data comprises:
producing the augmented data to a streaming system; or
storing the augmented data to a data store.

10. The method of claim 1, further comprising:
reading the plurality of input records; and
adapting to a format of the plurality of input records.

11. A system for filtering high volume data, comprising:
one or more processors; and
a memory coupled to the one or more processors to store instructions, which when executed by the one or more processors, cause the one or more processors to perform operations, the operations comprising:
obtaining reference data;
creating an index of reference data based on the obtained reference data; and
for each input record from a plurality of input records,
looking up the input record against the index of reference data to locate a match or a possible match,
producing augmented data based on the input record and the located match or possible match, and
publishing or storing the augmented data.

12. The system of claim 11, wherein creating the index of reference data comprises:
splitting the reference data into a plurality of tokens;
locating a node of a data structure having a value that matches a value of a token among the plurality of tokens;
determining whether the node of the data structure exists;
in response to determining that the node exists, advancing to a next token among the plurality of tokens; and
in response to determining that the node does not exist, creating the node for the value of the token.

13. The system of claim 12, wherein creating the index of reference data further comprises:
adding the reference data as a value of a current node of the data structure.

14. The system of claim 13, wherein the data structure is a trie data structure.

15. The system of claim 11, wherein looking up the input record against the index of reference data to locate the match or possible match comprises:
splitting the input record into a plurality of tokens;
determining whether a node of a data structure has a value, wherein the data structure represents the index of reference data;
in response to determining that the node of the data structure has a value, determining whether the value matches a value of a token among the plurality of tokens;
in response to determining that the value matches the value of the token, moving to the node, and advancing to a next token among the plurality of tokens; and
in response to determining that the value does not match the value of the token, adding the node to a data structure of possible match.

16. The system of claim 15, wherein looking up the input record against the index of reference data to locate the match or possible match further comprises:
using a top entry in the data structure of possible match as a best match.

17. The system of claim 11, wherein producing the augmented data comprises:
loading configuration data;
determining a rule type from the configuration data;
in response to the rule type, obtaining or computing a value of best match from a data structure of possible match, or computing a value from one or more matching reference data entries of a data structure of matching reference data; and
attaching the obtained or computed value of best match, or the computed value from the one or more matching reference data entries to the input record to produce the augmented data.

18. The system of claim 17, wherein the data structure of possible match and the data structure of matching reference data are a stack data structure.

19. The system of claim 11, wherein publishing or storing the augmented data comprises:
producing the augmented data to a streaming system; or
storing the augmented data to a data store.

20. The system of claim 11, wherein the operations further comprise:
reading the plurality of input records; and
adapting to a format of the plurality of input records.
